(19) United States
(12) Patent Application Publication
(10) Pub. No.: US 2018/0136401 A1
(43) Pub. Date: May 17, 2018

(54) TRANSCEIVER HIGH DENSITY MODULE

(71) Applicant: Kaiam corp., Newark, CA (US)

(72) Inventors: Bardia Pezeshki, Menlo Park, CA (US); Ramsey Selim, Edinburgh (GB); John Heanue, Boston, MA (US); Henk Bulthuis, Newark, CA (US); Susannah Heck, Edinburgh (GB)

(21) Appl. No.: 15/812,273

(22) Filed: Nov. 14, 2017

Related U.S. Application Data
(60) Provisional application No. 62/421,966, filed on Nov. 14, 2016.

(51) Int. Cl. G02B 6/30; G02B 6/32

(52) U.S. Cl. CPC G02B 6/30; G02B 6/32

(57) ABSTRACT

An optical coupler couples light from waveguides of a photonic integrated circuit (PIC) to output waveguides, for example waveguides of a planar lightwave circuit (PLC). The optical coupler includes optical elements having different optical properties. In some embodiments the optical properties vary to account for waveguide angled facets in the PIC, and in some embodiments the optical properties vary to account for the PIC being mounted at an angle compared to the PLC, or optical coupler.

### CROSS REFERENCE TO RELATED APPLICATION

This invention claims priority to U.S. Provisional Patent Application 62/421,966 entitled “Transceiver High Density Module” filed on Nov. 14, 2016, that is hereby incorporated by reference in its entirety as if set forth herewith.

### BACKGROUND OF THE INVENTION

The present invention relates generally to optical transceivers, and more particularly to optical arrangements for components of optical transceivers.

Optical communication systems can generally support high data rates, and do so with lower power consumption and with reduced signal loss or interference over appreciable distances, compared to for example electrical signal paths of similar length. For these reasons, and others, optical transceivers coupled to optical fibers have long been used for long-haul communication systems.

For shorter distance communication, for example in data center environments, optical communication systems are also increasingly being used. In data center environments, however, space may be at a premium. Accordingly, use of co-packaged high density modules that provide multiple lanes of communication may be desired.

Photonic integrated circuits (PICs) may be used in such modules, whether transceiver modules or other modules. PICs may include a laser for providing light to carry a data signal, and, for example, a waveguide to carry the light to an edge of the PIC. The waveguide may include an angle, changing direction of the waveguide, as it approaches an edge, or facet, of the PIC chip. This waveguide angled facet may be useful in reducing reflections back towards the laser or other optical component. Unfortunately, the waveguide angle facet also results in light from the waveguide not exiting the PIC chip at an angle normal to the PIC chip, which may cause problems in coupling light from the PIC chip to other optical components, for example particularly doing so without undue loss of optical power. These problems may be exacerbated when the PIC chip includes arrays of lasers with corresponding arrays of waveguides.

### BRIEF SUMMARY OF THE INVENTION

Some embodiments in accordance with aspects of the invention provide an optical module including a Phototonic Integrated Circuit (PIC), an output medium, and an optical coupler. The PIC may have an array of waveguides. Each of the waveguides emits light emits light having an angle of incidence that is non-zero and has an angle facet that is non-normal with respect to an output edge of the PLC. The optical coupler may include one or more optical elements for coupling light from the waveguides of the PIC to the output medium. Each of the optical elements may focus light from one of the waveguides at a focal length that is the same as a focal length of the other optical elements. Furthermore, each of the optical elements may have unique optical properties determined by a device distance between the optical element and the associated waveguide.

In accordance with some embodiments, the optical coupler may include a first lens array. Each lens in the first lens array may focuses the light from one of the waveguides of the PIC and has a radius of curvature that is based upon the focal length of the lens and a device distance of the waveguide emitting the light focused by the lens. In accordance with many of these embodiments, the optical coupler may include a step index box made of material that causes the light emitted from each of the waveguides to have the same effective device distance and each lens in the first lens array has the same radius of curvature based on the light emitted from the waveguides having the same effective device distance.

In accordance with some embodiments, the optical coupler includes a plurality of collimating lenses wherein each of the plurality of collimating lenses collimates light from one of the waveguides of the PIC into one lens of the first lens array and each lens of the first lens array focus the collimated light onto a single portion of the output medium.

In accordance with a number of these embodiments, the optical coupler may also include a second lens array. Each lens in the first lens array focuses light onto one lens of the second lens array and each lens of the second lens array focuses light on a particular portion of the output medium.

In some of these embodiments, each lens of the first lens array collimates light from one of the waveguides onto one lens of the second lens array and each lens of the second lens array focuses the collimated light onto a particular portion of the output medium. In some of these embodiments, each lens in the first lens array may be a glass ball lens and each lens in the second lens array may be a glass ball lens. In accordance with some other embodiments, each lens in the first lens array may be a silicon ball lens and each lens in the second lens array may be a glass ball lens. In a number of these embodiments, at least one lens in the first lens array and/or the second lens array is mounted on a moveable MEMs platform.

In accordance with many embodiments, the optical coupler may include an isolator between the PIC and the output medium. In accordance with a few embodiments, the optical elements are portions of a larger full lens.

In accordance with some embodiments, the output medium may include one or more optic fibers. In accordance with some other embodiments, the output medium is a planar lightwave circuit (PLC). In accordance with some of these embodiments, he PIC and the PLC are offset from one another such that exit directions of light from the waveguides of the PIC approach entrance directions of light into waveguides of the PLC. In accordance with a few of these embodiments, the PIC is at an angle with respect to the optical coupler such that the light emitted by the waveguides of the PIC is at a non-normal angle to a front facet edge of the PIC and arrives at the optical coupler at a non-normal angle.

Some embodiments in accordance with aspects of the invention provide an optical module having an array of waveguides, each with angle facets, and a planar lightwave circuit (PLC), with an optical coupler coupling light from the PIC to the PLC, with an edge of the PIC at an angle to a closest edge of the PLC, and the optical coupler including a plurality of elements, which may be lenses, each with a different optical property.

In some such embodiments outputs of the different PIC waveguides are at different distances to the optical coupler, and inputs of the PLC are at the same distance to the optical coupler. In some such embodiments the plurality of lenses have an aspheric output surface, each with a different radius of curvature. In some such embodiments the radius of curvature of each of the lenses is such that the focal length of each lens, in view of the varying distances to the waveguide outputs, is the same.

In some embodiments a step index block is interposed between the PIC and the optical coupler. In some embodiments the step index block serves to provide a common distance for free-space propagation of light from the waveguides of the PIC.

In some embodiments the lenses are mounted on a MEMs structure, allowing for correction of misalignment of the PIC and PLC.

These and other aspects and embodiments of the invention are more fully comprehended upon review of this disclosure.

### BRIEF DESCRIPTION OF THE FIGURES

FIG. 1 is a block diagram of portions of an optical module in accordance with aspects of the invention.

FIG. 2 is a descriptive diagram of portions of an optical module in accordance with aspects of the invention.

FIG. 3 is a semi-block diagram, semi-illustration of portions of an optical transceiver in accordance with aspects of the invention.

FIG. 4 is a semi-block diagram, semi-illustration of portions of a further optical transceiver in accordance with aspects of the invention.

FIG. 5 is a schematic showing optical alignment between a PIC and a PLC in accordance with aspects of the invention.

FIG. 6 is a schematic showing a further optical alignment between a PIC 311 and a PLC 619 in accordance with aspects of the invention.

FIG. 7 shows a further optical arrangement in accordance with aspects of the invention.

FIG. 8 shows a yet further optical arrangement in accordance with aspects of the invention.

FIG. 9 is a semi-block diagram, semi-illustration of portions of a still further optical transceiver in accordance with aspects of the invention.

FIG. 10 is a semi-schematic, semi-block diagram of an optical module having a telescopic configuration in accordance with aspects of the invention.

FIG. 11 is a yet further semi-schematic, semi-block diagram of an optical module having a telescopic configuration in accordance with aspects of the invention.

### DETAILED DESCRIPTION

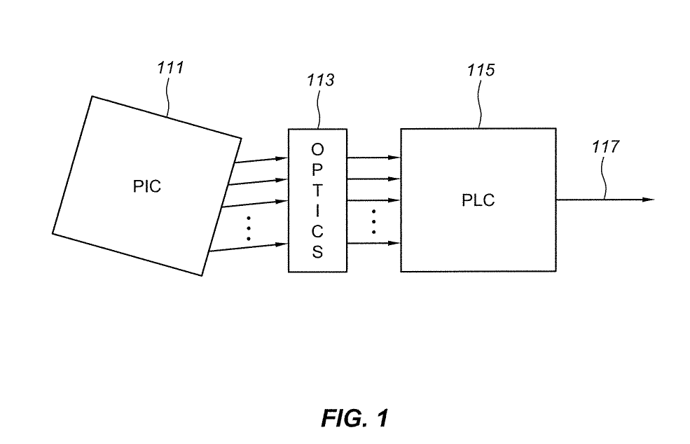

FIG. 1 is a block diagram of portions of an optical module in accordance with aspects of the invention. The module, which may be of a transceiver module, a rotator combiner module, or other module, includes a photonic integrated circuit (PIC) 111. The PIC 111 includes for example waveguides passing light to an output facet of the PIC. The light may be from, for example, lasers in the PIC 111, and/or the PIC 111 may include modulators, semiconductor optical amplifiers, and/or other optical devices. As shown in FIG. 1, the light passes through optics 113 to arrive at a planar lightwave circuit (PLC) 115. The optics 113 includes one or more optical elements, generally one or more lenses, to focus the light into waveguides of the PLC 115. The PLC 115 operates on the light, for example the PLC 115 may serve to multiplex the light for provision to an optical fiber 117. In this regard the PLC 115 may be considered an example output medium, for example of a material different than the PIC 111. In various embodiments the PLC 115 of FIG. 1 may be replaced by other substrates, for example a silicon photonics substrate, optical fibers, or other optical mediums. In general, and in most embodiments, the PIC 111 and the PLC 115 include tightly packed waveguides, with material of the PIC 111 and the PLC 115 having different refractive indexes.

In the embodiment of FIG. 1, light exiting the PIC 111 towards the optics 113 is shown as exiting the PIC 111 at a non-normal (e.g. non-orthogonal) angle to a front facet, or edge, of the PIC 111, and arriving at the optics 113 also at a non-normal angle. In various embodiments, this is the case due to one, several, or all of the PIC 111 being mounted to a substrate at an angle with respect to the optics 113, waveguides internal to the PIC 111 having a waveguide angled facet, and differences in index of refraction between the PIC 111 and space or material between the PIC 111 and the optics 113. In addition, or in some embodiments as a result of such an arrangement, distance between the PIC 111 and the optics 113, and more particularly distance between the PIC 111 and the optics 113 traveled by light exiting the PIC 111, varies for light from different waveguides of the PIC 111.

The optical elements of the optics 113 vary so as to focus light from each of the waveguides of the PIC 111 to corresponding waveguides of the PLC 115. In some embodiments, the optical elements 113 have varying optical properties. In some embodiments, the optical elements 113 have optical properties that vary such that different ones of the optical elements focus images at the same image distance despite different object distances for the different ones of the optical elements 113. In some embodiments, the optical elements 113 are arranged in a linear array, with successive optical elements in the linear array having an output surface, with the output surface of each successive optical element having a different radius of curvature. In some embodiments the output surfaces are aspheric. In some embodiments, the optical elements 113 are lenses. In some embodiments the lenses have an aspheric output surface, with at least some of the lenses having different radius of curvature for the aspheric output surface. In some embodiments, the lenses (or array of lenses) are mounted on a moveable MEMs platform, to allow for positioning of the lenses to focus light from the PIC 111 into waveguides of the PLC 115. In some embodiments, the moveable MEMs platform is as discussed in U.S. Pat. No. 8,346,037 entitled “MICROMECHANICALLY ALIGNED OPTICAL ASSEMBLY” or U.S. Pat. No. 8,917,963, entitled “MEMS-BASED LEVERS AND THEIR USE FOR ALIGNMENT OF OPTICAL ELEMENTS” the disclosures of which are incorporated by reference.

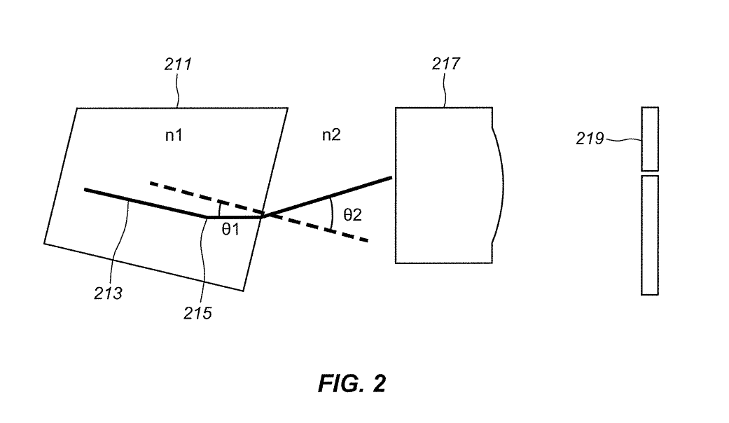

FIG. 2 is a descriptive diagram of portions of an optical module, for example of a transceiver, in accordance with aspects of the invention. In FIG. 2, a PIC 211 includes a plurality of waveguides, with only a single waveguide 213 shown for illustrative purposes. Light from the PIC 211 is directed to an optical element 217, which focuses the light on a waveguide of a PLC 219.

For the PIC 211, the waveguides may be used, for example, for passing light from a laser or other light source (not shown in FIG. 2) out to an edge of the PIC 211. As illustrated in FIG. 2, the waveguide 213 includes a change in direction 215, which may be termed an angle facet, near the output edge of the PIC 211. The angle facet 215 may be beneficial, for example, in reducing reflections back down the waveguide towards the laser.

The angle facet, however, results in the waveguide 213 being at an angle non-normal to the output edge of the PLC 211, with the angle being shown as θ1 in FIG. 2. In other words, the angle of incidence of light in the waveguide is non-zero. Considering that the PIC 211 and the free space outside of the PIC 211 have different refractive indices, the angle of refraction for light exiting the PIC 211 will be θ2, as shown in FIG. 2, in accordance with Snell's Law.

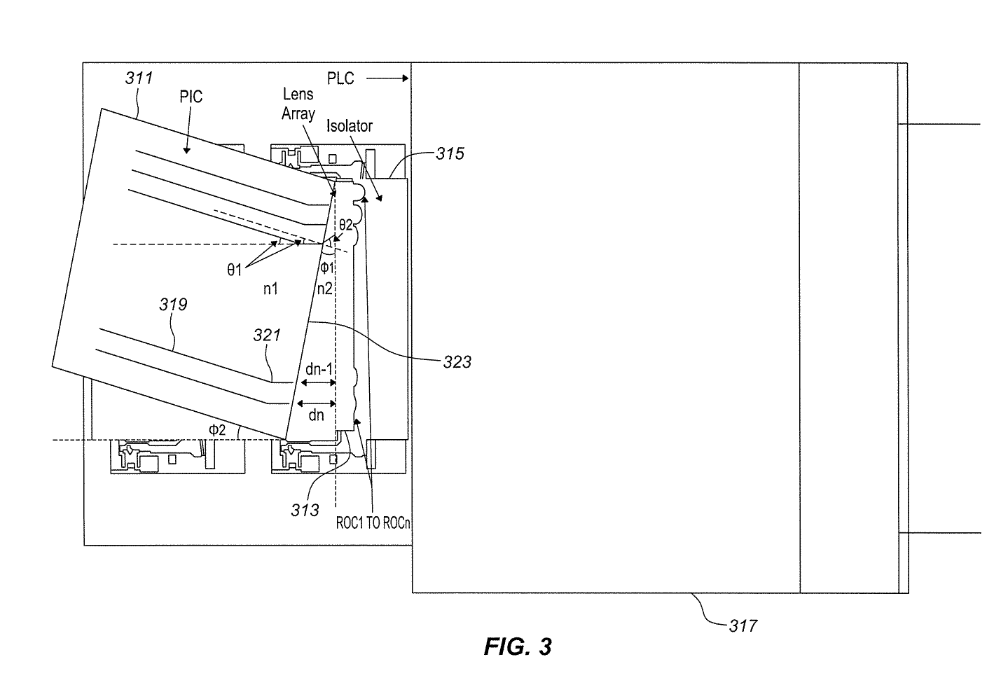

FIG. 3 is a semi-block diagram, semi-illustration of portions of an optical transceiver in accordance with aspects of the invention. The optical transceiver includes a PIC 311. The PIC 311 provides light that is passed to a PLC 317. A lens array 313 focuses light from the PIC 311 into waveguides of the PLC 317, with an optical isolator 315 interposed between the lens array 313 and the PLC 317. The PLC 317 includes an optical multiplexer, for example in the form of an arrayed waveguide grating (AWG), for multiplexing the light into fewer outputs, for example a single output.

The PIC 311 includes a plurality of light sources, for example lasers, to provide light to be passed out of the PIC 311 through a plurality of waveguides, for example waveguide 319. The waveguides include angle facets, for example angle facet 321, near an output edge 323 of the PIC 311. The angle facets have an angle θ1, with respect to the waveguides, which are perpendicular to the output edge 323 of the PIC 311. Due to refraction, light exiting the waveguides will do so at an angle θ2 with respect to a normal to the output edge of the PLC 317.

For example to reduce the angle at which the light approaches the lens array 313, the PIC 311 in the embodiment of FIG. 3 is orientated at a non-zero angle, ϕ, with respect to, for example the lens array 313 and PLC 317. With the PIC 311 angled at the non-zero angle ϕ, light from the waveguides of the PIC 311 travels differing distances before reaching the lens array 313 313. For example, light from a first waveguide may travel a distance d₁ before reaching the lens array 313, light from a second waveguide may travel a distance d₂ before reaching the lens array 313, . . . , light traveling from an nth-1 waveguide may travel a distance dₙ₋₁ before reaching the lens array 313, and light traveling from an nth waveguide may travel a distance dₙ before reaching the lens array 313.

The lens array 313 focuses the light from the PIC 311 into waveguides of the PLC 317. Preferably the lenses of the lens array 313 does so to maximize power into the waveguides of the PLC 317. In some embodiments, depending on the relative angle of approach of light from the PIC 311, and, in some embodiments, position of the PLC 317, lenses of the lens array 313 may be aspheric. In addition, for the lens array 313, although the image distance is generally the same for each lens, as each of the lenses are generally the same distance to the PLC 311. The object distance, however, differs for each lens, considering that the distance from the output edge 323 of the PIC 311 to the lens array varies. Accordingly, the focal length of the lenses also varies. In FIG. 3, this is shown with the radius of curvature of the lenses varying from a first radius of curvature ROC₁ to an nth radius of curvature ROCₙ. Considering that the object distance increases for each successive lens of the lens array 313 in the embodiment of FIG. 3, the radius of curvature also increases for each successive lens of the lens array 313.

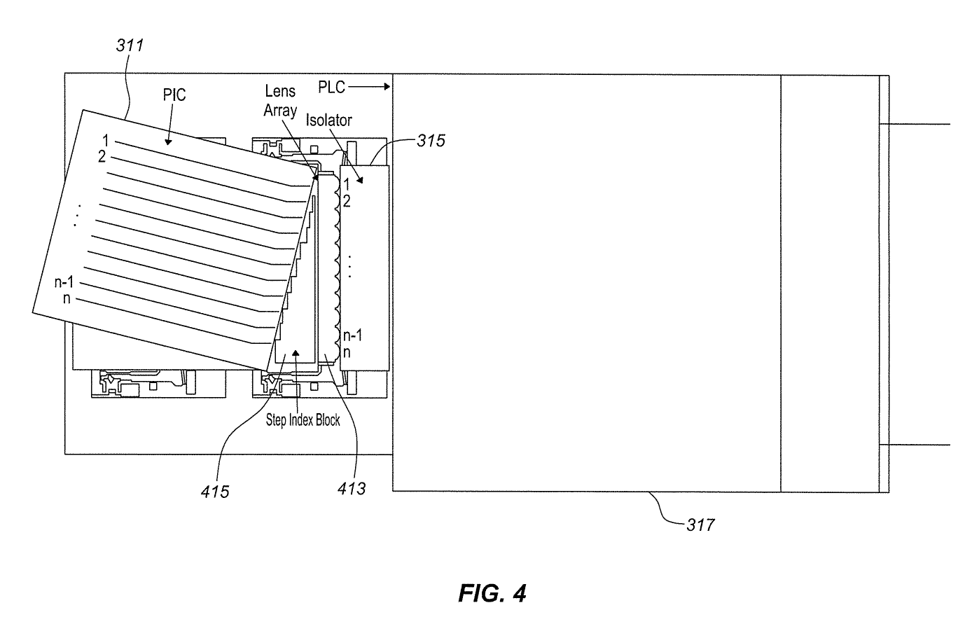

FIG. 4 is a semi-block diagram, semi-illustration of portions of a further optical transceiver in accordance with aspects of the invention. The embodiment of FIG. 4 is similar to that of the embodiment of FIG. 3, for example including the PIC 311, the optical isolator 315, and the PLC 317 of FIG. 3.

The embodiment of FIG. 4 additionally includes a step index block 415 between the PLC and a lens array 413. The step index block 415 includes material such that light passing from different ones of the output waveguides have the same effective optical object distance from the lens array 413, despite differing physical distances. For example, light traveling from a first waveguide of the PIC 311 to the lens array 413 may encounter material having a first refractive index in the step index block 415, light traveling from a second waveguide of the PIC 311 to the lens array 413 may encounter material having a second refractive index, and so on. The refractive index of the materials may be set such that the effective optical distance between the PIC 311 and the lens array 413 is a constant. In such embodiments, lenses of the lens array 413 may have the same focal length, and may for example have the same radius of curvature. Alternatively, in some embodiments the refractive index of various portions of the step index block 415 may vary, but not sufficiently so as to allow for lenses of the lens array 413 to have the same radius of curvature.

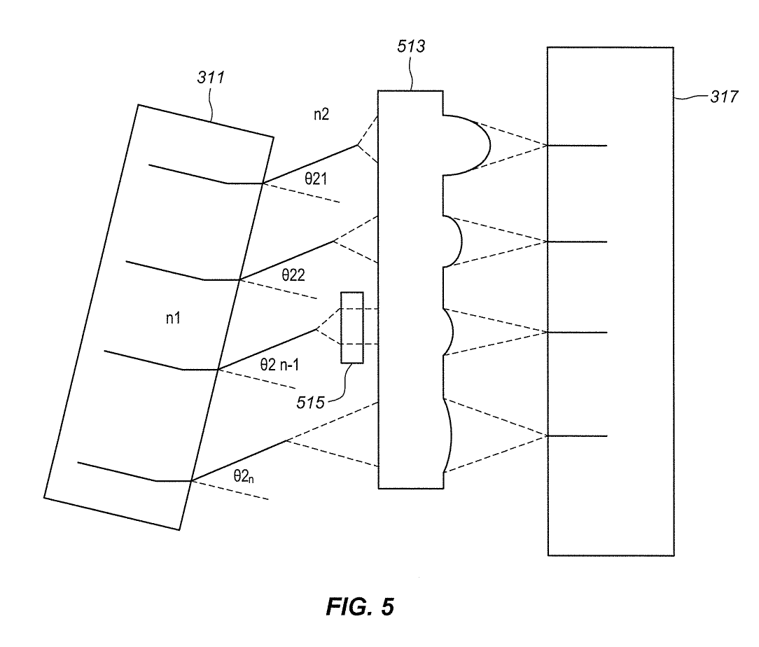

FIG. 5 is a schematic showing optical alignment between a PIC 311 and a PLC 317 in accordance with aspects of the invention. The PIC 311 of FIG. 5 may be the PIC of FIG. 3, and the PLC 317 of FIG. 5 may be the PLC of FIG. 3. The PIC 311 may or may not be positioned at an angle with respect to the lens array 513 and/or PLC 317, as discussed above. A lens array 513 is positioned between the PIC 311 and the PLC 317. An optical isolator may also be positioned between the lens array 513 and the PLC 317, or between the PIC 311 and the lens array 513, but is omitted from FIG. 5 for clarity.

The lens array 513 focuses light from each of the waveguides of the PIC 311 into corresponding waveguides of the PLC 317. To do so, considering the different optical distances between the different PIC waveguide-lens pairs, the lenses generally have different radii of curvature.

In addition, in some embodiments, and for example as shown in FIG. 5, one or more collimating lenses 515 may be placed between the PIC 311 and the lens array 513. Thus, as illustrated in FIG. 5, a collimating lens 515 collimates light from one of the waveguides of the PIC 311 into the lens array 513. There may be many advantages to use of such collimating lenses, for example allowing for use of spheric or less aspheric lenses in the array of lenses 513, reduced physical space (in the form of reduced height in FIG. 5) for lenses in the array of lenses 513, and other advantages.

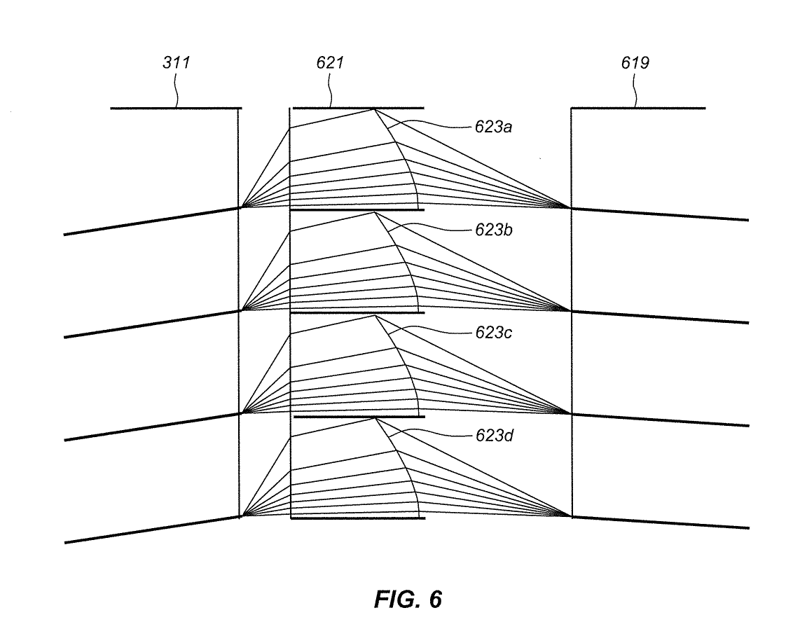

FIG. 6 is a schematic showing a further optical alignment between a PIC 311 and a PLC 619 in accordance with aspects of the invention. As in FIG. 5, the PIC of FIG. 6 may be the PIC of FIG. 3, and the PIC 311 may or may not be positioned at an angle with respect to the lens array 621 and/or PLC 619, as discussed above. In the embodiment of FIG. 6, the PIC 311 is not positioned at an angle with respect to the lens array and PLC 619. The PLC 619 may be the PLC of FIG. 3, and in some embodiments the PLC 619 may have angled waveguides with respect to an input face of the PLC 619.

In FIG. 6, the lens array 621 is comprised of a plurality of elements 623a-d. In most embodiments the elements 623a-d are portions of a larger full lens. Unlike for example the embodiment of FIG. 3, each of the elements 623a-d have the same optical properties.

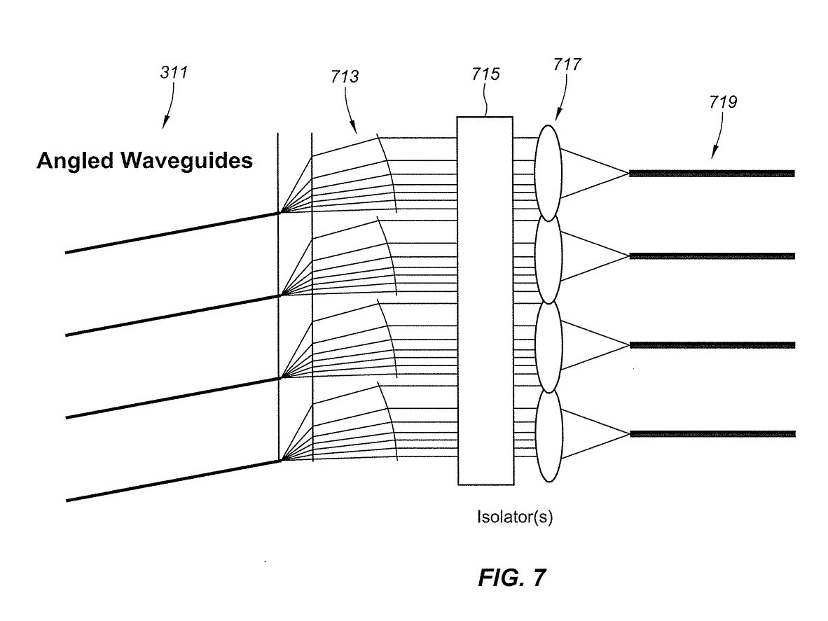

FIG. 7 shows a further optical arrangement in accordance with aspects of the invention. The arrangement of FIG. 7 includes a PIC 311, which may be the same as the PIC of FIG. 3. In the embodiment of FIG. 7, the PIC 311 is not oriented at an angle to other components.

Light from waveguides of the PIC 311 are collimated by lenses of a lens array 713. In many embodiments the lenses are portions of a larger full lens. The collimated light is passed through one or more optical isolators 715, and focused by further lenses 717 into an output medium. In FIG. 7, the output medium is a plurality of optical fibers 719. The optical fibers 719 may be used in place of a PLC, and the optical fibers 719 of FIG. 7 may be used in place of the PLCs discussed with respect to other embodiments.

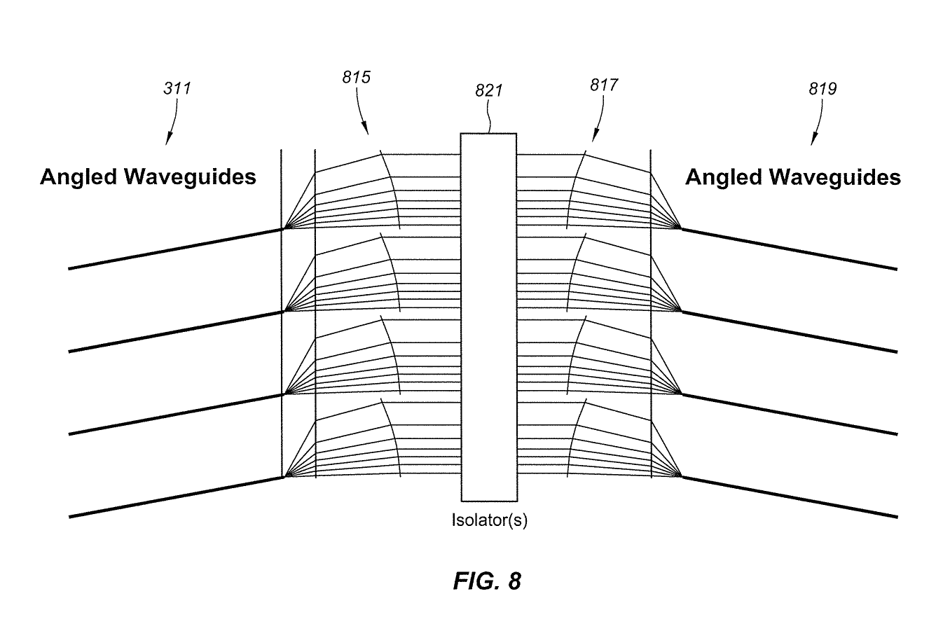

FIG. 8 shows a yet further optical arrangement in accordance with aspects of the invention. As in FIG. 7, the arrangement of FIG. 8 includes a PIC 311, which may be the same as the PIC of FIG. 3. In the embodiment of FIG. 8, the PIC 311 is not oriented at an angle to other components. Light from waveguides of the PIC 311 is passed to corresponding angled waveguides of a PLC 819. In doing so, the light is passed through a first array of lenses 815 and a second array of lenses 817, with one or more optical isolators 821 between the first array of lenses 815 and the second array of lenses 817.

In some embodiments, and as illustrated in FIG. 8, the first array of lenses 815 collimates light from the PIC 311, and the second array of lenses 817 focuses the collimated light into angled waveguides of the PLC 819. In many embodiments the lenses are portions of a larger full lens.

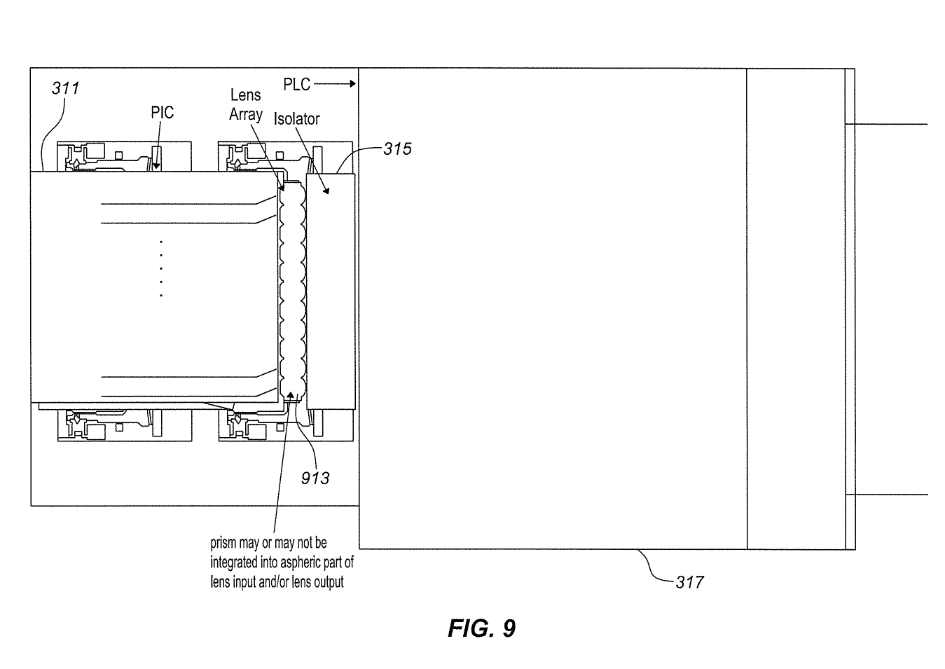

FIG. 9 is a semi-block diagram, semi-illustration of portions of a still further optical transceiver in accordance with aspects of the invention. In FIG. 9, a PIC 311 provides light from a plurality of angled facet waveguides. The PIC 311 may be the same as the PIC of FIG. 3, although in the embodiment of FIG. 9 the PIC 311 is not oriented at an angle with respect to other components.

Light from the waveguides of the PIC 311 is passed through an array of lenses 913. The array of lenses 913 includes bi-concave lens for focusing light into waveguides of a PLC 317. In most embodiments the lenses, or the input or output lenses, are aspheric, to account for the angle at which light reaches the lenses from the angled facet waveguides of the PIC 311. As with several other embodiments, an optical isolator 315 is between the array of lenses 913 and the PLC 317.

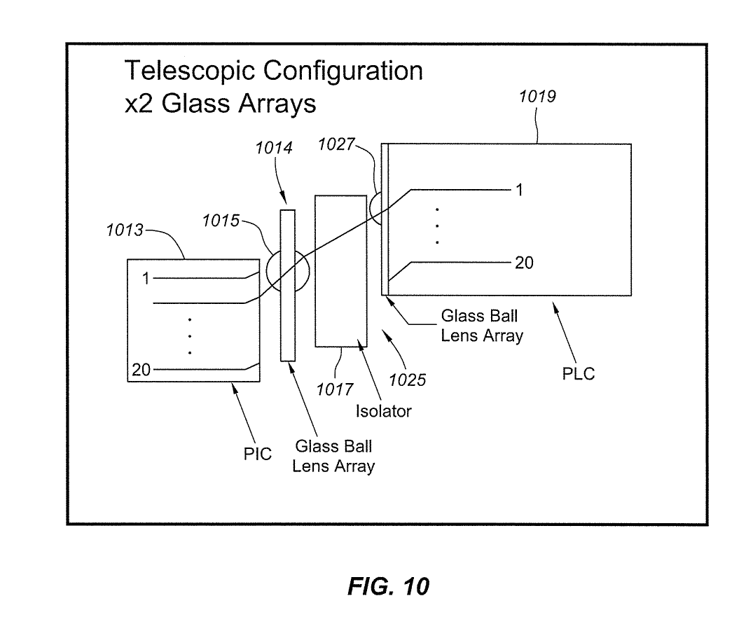

FIG. 10 shows a further embodiment of an optical module in accordance with aspects of the invention. In FIG. 10 a PIC 1013 provides light from a plurality of waveguides, and the light is received by a corresponding plurality of waveguides in a receiving item, for example a PLC 1019. In FIG. 10, waveguides of both the PIC 1013 and the PLC 1019 have waveguide angled facets. In addition, in some embodiments, and as illustrated in FIG. 10, the PIC 1013 and the PLC 1019 are offset from one another. For example, in some embodiments the PIC 1013 and the PLC 1019 may be offset from one another such that exit directions of light from waveguides of the PIC approach entrance directions of light into waveguides of the PIC.

A first lens array 1014 directs light from the PIC 1013 towards a second lens array 1025. The second lens array 1025 directs light into waveguides of the PLC 1019. In some embodiments the first lens array 1014 includes a plurality of glass ball lenses, for example glass ball lens 1015. In some embodiments the second lens array 1025 also includes a plurality of glass ball lenses, for example, glass ball lens 1027. An optical isolator 1017 is between the two lens arrays.

Also in the embodiment of FIG. 10, the first glass ball lens 1015 is shown as a full ball, while the second glass ball lens 1027 is shown as a half-ball. Moreover, in the embodiment of FIG. 10, the second lens array 1025 is shown mounted to the PLC 1019.

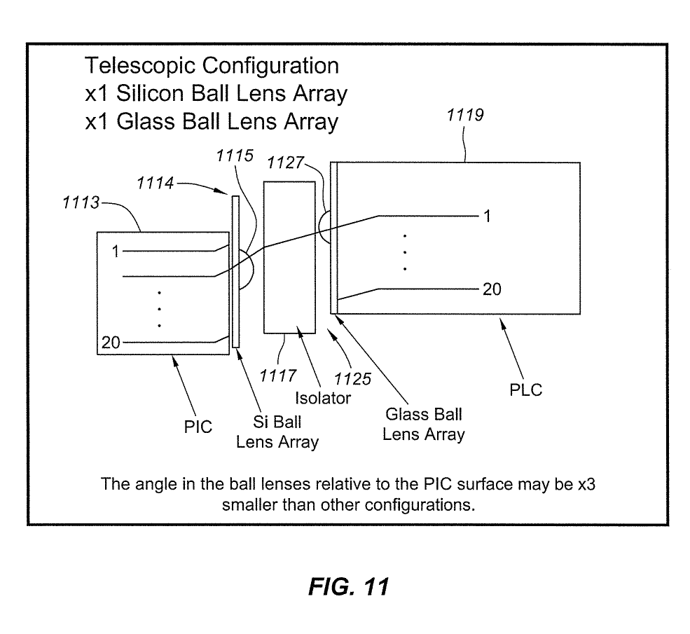

FIG. 11 shows a yet further embodiment of an optical module in accordance with aspects of the invention. In FIG. 11, as in FIG. 10, a PIC 1113 provides light from a plurality of waveguides, and the light is received by a corresponding plurality of waveguides in a receiving item, for example a PLC 1119. In FIG. 11, waveguides of both the PIC 1113 and the PLC 1119 have waveguide angled facets. In addition, in some embodiments, and as illustrated in FIG. 11, the PIC 1113 and the PLC 1119 are offset from one another. For example, in some embodiments the PIC 1113 and the PLC 1119 may be offset from one another such that exit directions of light from waveguides of the PIC 1113 approach entrance directions of light into waveguides of the PLC 1119.

A first lens array 1114 directs light from the PIC 1113 towards a second lens array 1125. The second lens array 1125 directs light into waveguides of the PLC 1119. An optical isolator 1117 is between the two lens arrays. In the embodiment of FIG. 11, the first lens array 1114 is a silicon ball lens array as shown for example by silicon ball lens 1115, and the second lens array 1125 is a glass ball lens array as shown for example by glass ball lens 1127. In the embodiment of FIG. 11, both the balls of the two lens arrays are shown as half balls.

Although the invention has been discussed with respect to various embodiments, it should be recognized that the invention comprises the novel and non-obvious claims supported by this disclosure.

What is claimed is:

1. An optical module, comprising:
a phototonic integrated circuit (PIC) having a plurality of waveguides configured to emit light at a non-zero angle to an output edge of the PIC, each of the plurality of waveguides having a waveguide angle facet;
an output medium; and
an optical coupler including a plurality of optical elements for coupling light from the plurality of waveguides of the PIC to the output medium wherein each one of the plurality of optical elements focuses light from one of the plurality of waveguides at a focal length that is the same as a focal length of other ones of the plurality of optical elements and has optical properties that vary based on a distance between the one of the plurality of optical elements and the associated one of the plurality of waveguides.

2. The optical module of claim 1 wherein the optical coupler includes a first lens array of a plurality of lens wherein each lens in the first lens array focuses the light from one of the plurality of waveguides of the PIC and has a radius of curvature based upon the focal length and a device distance of the one of the plurality of waveguides emitting the light focused by the lens.

3. The optical module of claim 2 wherein the optical coupler includes a step index box made of material that causes the light emitted from each of the plurality of waveguides to have the same effective device distance and each lens in the first lens array has the same radius of curvature based on the light emitted from the waveguides having the same effective device distance.

4. The optical module of claim 2 wherein the optical coupler includes a plurality of collimating lenses wherein each of the plurality of collimating lenses collimates light from one of the waveguides of the PIC into one lens of the first lens array and each lens of the first lens array focus the collimated light onto a single portion of the output medium.

5. The optical module of claim 2 wherein the optical coupler further comprises a second lens array of a plurality of lenses wherein each lens in the first lens array focuses light onto one lens of the second lens array and each lens of the second lens array focuses light on a particular portion of the output medium.

6. The optical module of claim 5 wherein each lens of the first lens array collimates light from one of the plurality of waveguides onto one lens of the second lens array and each lens of the second lens array focuses the collimated light from a lens of the first lens array onto a particular portion of the output medium.

7. The optical module of claim 5 wherein each lens in the first lens array is a glass ball lens and each lens in the second lens array is a glass ball lens.

8. The optical module of claim 5 wherein each lens in the first lens array is a silicon ball lens and each lens in the second lens array is a glass ball lens.

9. The optical module of claim 5 wherein at least one lens in the first lens array and at least one lens in the second lens array are each mounted on a moveable MEMs platform.

10. The optical module claim 2 wherein a lens of the first lens array is mounted on a moveable MEMs module.

11. The optical module of claim 1 wherein the optical coupler includes an isolator between the PIC and the output medium.

12. The optical module of claim 1 wherein the plurality of elements are portions of a larger full lens.

13. The optical module of claim 1 wherein the output medium comprises a plurality of optic fibers.

14. The optical module of claim 1 wherein the output medium is a planar lightwave circuit (PLC).

15. The optical module of claim 1 wherein the PIC and the PLC are offset from one another such that exit directions of light from the plurality of waveguides of the PIC approach entrance directions of light into a plurality of waveguides of the PLC.

16. The optical module of claim 1 wherein the PIC is at an angle with respect to the optical coupler such that the light emitted by the plurality of waveguides of the PIC is at a non-normal angle to a front facet edge of the PIC and arrives at the optical coupler at a non-normal angle.

17. A method for transmitting light from a plurality of waveguides of a phototonic integrated circuit (PIC) to an output medium wherein each of the plurality of waveguides emits light having an angle of incidence that is non-zero and has an angle facet that is non-normal with respect to an input edge of a planar lightwave circuit (PLC), the method comprising:
emitting light from each of the plurality of waveguides of the PIC; and
coupling light from the plurality of waveguides of the PIC to the PLC using a plurality of optical elements wherein each of the plurality of optical elements focuses light from one of the plurality of waveguides on the output medium at a focal length that is the same as a focal length of other ones of the plurality of optical elements and has optical properties that vary based on a distance between the one of the plurality of optical elements and the one of the plurality of waveguides.
